(19) United States
(12) Patent Application Publication
(10) Pub. No.: US 2002/0116533 A1
(43) Pub. Date: Aug. 22, 2002

(54) System for providing a multimedia peer-to-peer computing platform

(76) Inventors: Matthew J. Holliman, Sunnyvale, CA (US); Rainer W. Lienhart, Santa Clara, CA (US); Minerva M. Yeung, Sunnyvale, CA (US); Yen-Kuang Chen, Sunnyvale, CA (US); Igor V. Kozintsev, San Jose, CA (US); Li-Cheng Tai, San Jose, CA (US)

Correspondence Address: John P. Ward, BLAKELY, SOKOLOFF, TAYLOR, & ZAFMAN LLP, Seventh Floor, 12400 Wilshire Boulevard, Los Angeles, CA, 90025-1026, US

(21) Appl. No.: 09/877,687

(22) Filed: Jun. 8, 2001

Related U.S. Application Data
(60) Provisional application No. 60/270,397, filed on Feb. 20, 2001.

(51) Int. Cl. G06F 15/16

(52) U.S. Cl. 709/246; 709/230

(57) ABSTRACT

A method and apparatus to support a first peer node receiving an inquiry for data from a second peer node. In one embodiment, the first peer node transcodes the data before transmitting the data to the second peer node, wherein the transcoding includes converting the data into a format that can be processed by the second peer node, and transmitting the data to the second peer node in a transport specification as requested by the second peer node.

### BACKGROUND

Peer-to-peer scenarios may be exemplified by the absence of a “server” in a traditional client-server environment. Such a paradigm may be viewed as an instance of distributed computing, where a system of (often heterogeneous) nodes operate in a cooperative or confederated fashion to complete a given task. A number of examples have been recently reported, including hybrid approaches such as that of Napster, which uses a centralized client-server model for lookups and direct peer-to-peer communication for file transfers, as well as completely distributed file sharing architectures such as Gnutella.

In general, peer-to-peer applications thus contrast to a traditional client's dependence on a server. In reality, however, the distinction between peer-to-peer and client-server is often blurred, and peer nodes can be viewed as taking on the roles of both a client and a server.

Current peer-to-peer infrastructures, however, typically do not provide flexible/dynamic support for operations such as multimedia services. For example, typical peer-to-peer infrastructures implement “download”-style data transfers via Transmission Control Protocol (TCP) only, despite the fact that multimedia can be streamed and viewed in real time using an unreliable protocol such as User Datagram Protocol (UDP). Compounding this problem, some peer-to-peer infrastructures do not even support direct source-to-destination transfers, instead propagating data node-by-node through the network.

Moreover, many current systems limit the scope of user queries to queries by filename, making it difficult for users to devise innovative new query mechanisms that can take advantage of the richer semantics of media content. Finally, multimedia files exhibit different characteristics than other files. Multimedia files can exist in a variety of different formats, resolutions, and qualities. Hence, depending on the end user's requirements, a multimedia-aware delivery system should be able to send the same in different format to different users.

As such, there is a need to support a more dynamic peer-to-peer platform for exchanging diverse data such as multi-media data.

### BRIEF DESCRIPTION OF THE DRAWINGS

FIG. 1 is a block diagram of the interoperation of peers within a Global Network Universe according to one embodiment.

FIG. 2 is a block diagram illustrating the support module according to one embodiment.

FIG. 3 is a block diagram of the interoperation of peers within a Global network Universe according to one embodiment.

FIG. 4 is a flow diagram describing the operations according to one embodiment.

### DETAILED DESCRIPTION

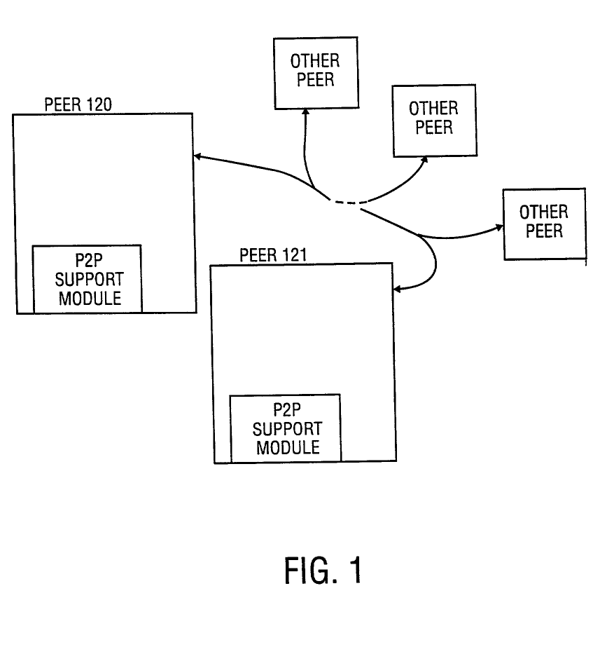

The present application describes a peer-to-peer (P2P) support module to improve sharing of data/resources in a peer-to-peer environment. Illustrated in FIG. 1 is a P2P network configuration of peers (e.g., nodes, computers, set-top boxes, ect.) One or more of the nodes within the network configuration may include a P2P support module of the present invention to improve the sharing of data/resources. As further illustrated in FIG. 1, node 120 includes a P2P support module, according to one embodiment, in the memory of the node.

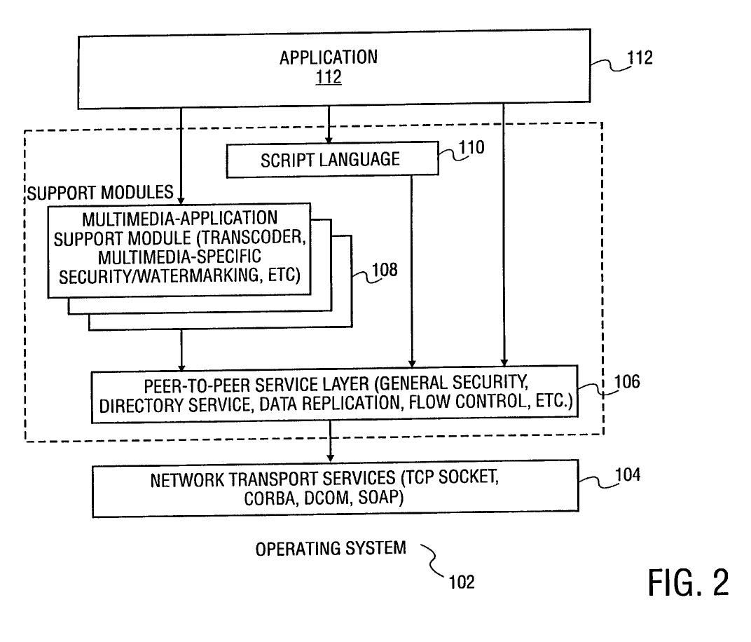

One characteristic of a Peer-to-peer environment is transparency of the physical location of a resource. That is, the location of data and other resources need not be determined by the applications using the peer-to-peer network. The data or resources (e.g., computation/Central Processing Unit (CPU) bandwidth, storage, etc.) can exist anywhere in the peer-to-peer global network universe, and the system handles the discovery and the delivery/utilization of the data/resource to the requesting application of a peer node. To support the transparency, in one embodiment, the P2P support module is separated from the traditional Operating System, as illustrated in more detail in FIG. 2. The P2P support module interfaces with the network transport services 104 of the operating system 102, according to one embodiment.

The P2P support module, in one embodiment as illustrated in node 120, includes P2P service layer 106 (described in greater detail below). In addition, the P2P support module includes support handlers 108, which provide transformation and computation services on the data/resources obtained via the peer-to-peer service layer 106. The handlers assist in making the system modular, flexible and extensible. For example, in one embodiment, the support modules may provide transcoding (format conversion) support (e.g., MPEG 2 to MPEG 4). In addition, the support modules may also provide multimedia watermarking, and other security features.

In addition, a scripting language interpreter 110, may also be provided to support applications 112 with programmatic access to the services provided by the P2P support module below.

In alternative embodiment, additional components/services may be provided and/or some of the components/services discussed above may not be included, without departing from the present invention.

A subset of the P2P support module, Tthe peer-to-peer service layer 106, supports providing the illusion of data location transparency throughout a network of nodes via the following features discussed in detail.

### Transport Mechanisms

In a peer-to-peer environment, data is likely to be transmitted over a variety of heterogeneous communication medium including telephone lines, high-speed wired networks, wireless local area networks, Bluetooth networks, and mobile cellular networks etc. Typically, in existing peer-to-peer networks, the transport protocols used are typically reliable in nature. While this approach masks the specifics of the underlying channel and is amenable to rapid prototyping and implementation, it may not be well suited for real-time delivery of multimedia data. Further, even in the case of delay-insensitive media data, wireless peers are likely to have limited storage resources and the concurrent playback and streaming of the data may thus be limited.

As such, considering the variety of different network conditions and setups on the Internet, a flexible peer-to-peer framework should support different transport mechanisms. In one embodiment, the network transport interface 104 between the peer-to-peer Service Layer 106 and the OS 102, is hot-pluggable. In particular, the network transport interface supports the incorporation of different transport handlers (e.g., TCP, RTP/UDP, etc.). As a result, in one embodiment, the peer support module allows the transport mechanism to be specified by the application, chosen from the set of available protocols supported by the network transport services.

For example, a video player application on a wireless handheld device might request to the peer services layer 106 that it only receive a video via RTP/UDP in combination with Forward Error Correction (FEC) and Automatic Repeat Request methods, in order to support real-time viewing of the stream. In contrast, a delay-insensitive application that prefetches and downloads videos on to a home server might specify the use of a simpler default protocol such as TCP as its transport protocol. The peer services layer 106 of the peer support module obtains the requested data at the source host(s) via the necessary protocol(s), pursuant to the request of the application.

Furthermore, in an alternative embodiment, the peer services layer provides support for wireless devices. In particular, the peer services layer is aware of the status of the wireless peer, such as battery state, location, mobility, etc., in addition to parameters common to the other peers (e.g. available bandwidth, screen resolution, available media players, etc). In one embodiment, wireless peers can announce their capabilities and status, for other peers to better accommodate media delivery to them. For example, if a wireless peer signals a low battery state, the other peers react by changing the media transport protocol for this wireless peer to be more power efficient (usually at the expense of reducing, e.g., media quality).

Furthermore, in an alternative embodiment, the application support module may adjust the personalization of content delivered to the device depending on its (device) location. For example, in a museum/exhibition a wireless peer device may receive access to the media content, which is linked to a particular item located in the vicinity on the peer device. Another example is having media data delivered to both the mobile device and another device (e.g., speakers, standalone monitor, display wall) that is located in the vicinity of a mobile device for synchronized delivery of multimedia data.

### Data Naming

In one embodiment, the peer-to-peer service layer 106 of the P2P support module supports user-defined representations of data. In one embodiment, the P2P service layer 106 may map user-defined names or metadata to a fixed Globally Unique Identifier (GUID), which may then be used by all peers to identify a piece of data and optionally track different copies of the data around the network.

In one embodiment, peer nodes throughout the network include directory services, which provide a view of where data is stored in the network. In one embodiment, the directory is a hash table mapping user-assigned names to the GUIDs, although in alternative embodiments, the directory may also support a tree structure or other organization structures. The directory services of different peer nodes may work in a cooperative fashion to help establish a view of the global network universe for each peer node. In another embodiment, which may be appropriate for relatively smaller systems requiring fast directory service lookups, global directory information may be duplicated across nodes.

In one embodiment of the P2P support module, user-specified query/resource handlers are provided in the peer nodes, to support customized queries better suited to individual content types. In this approach, in one embodiment, a user-specified query/resource handler in a peer node is used to locate a resource matching a given query. For example, a query for “video stream with mountains in the background” may be routed to a user-specified query/resource handler, which can use peer daemon Application Program Interfaces (APIs) to locate the requested resources.

In the case of directory service lookups, in one embodiment a peer daemon invokes the same query on other peers that support the same query mechanism. In an alternative embodiment, in addition to supporting user-defined queries, the system may provide a number of pre-defined query types that are available on all peers, e.g. to locate resources by filename, by file type, etc. Furthermore, in one embodiment of the system, peers on the network may cache the results to previous queries.

### Dynamic resource retrieval (transcoding)

In one embodiment, locating a version of a resource on the network is determined by a computation of a user-defined cost function (i.e., a metric that attempts to rank and prioritize available paths to the resource). In this context, a path consists of both a conventional network route and/or sequence of transformations throughout the network that are necessary to deliver the requested resource to the requesting node.

In order to deliver the requested version of a resource, existing copies of the requested resource may need to be transformed by the support modules 108 to satisfy constraints of the application/peer node requesting the resource. For example, in the case of requested video, existing content in MPEG-2 format may need to be downscaled spatially and temporally, quantized, and converted to a low bitrate MPEG-4 stream for viewing on a wireless device.

In another example, a user without access to Microsoft® PowerPoint® may request a version of a presentation as a GIF file only, which could result in dynamic transformation of the content to the necessary format. Such transcoding may be accomplished on demand on sufficiently powerful machines, or in another embodiment as the result of background processes operating on host nodes, which may perform speculative content adaptation, e.g. based on previous requests.

In one embodiment, the cost function and constraints imposed by the user would determine whether a new copy of the content would be generated, targeted specifically for the specific requirements, or whether an existing copy would suffice. By minimizing the computed cost function, the peer service layer determines the most appropriate technique for computing and obtaining the transformed resource or accessing a pre-stored version.

In addition, in one embodiment, the data to be transmitted could be transcoded based on the network bandwidth/error rate between peer nodes. In one embodiment, the data could be transcode into a low-bitrate content when network is congested and cannot handle a higher-bitrate streaming in real-time. In another embodiment, the data could be transcoded into a more error-resilient format when the communication link is wireless and the channel coding quality is low.

### System Implementation

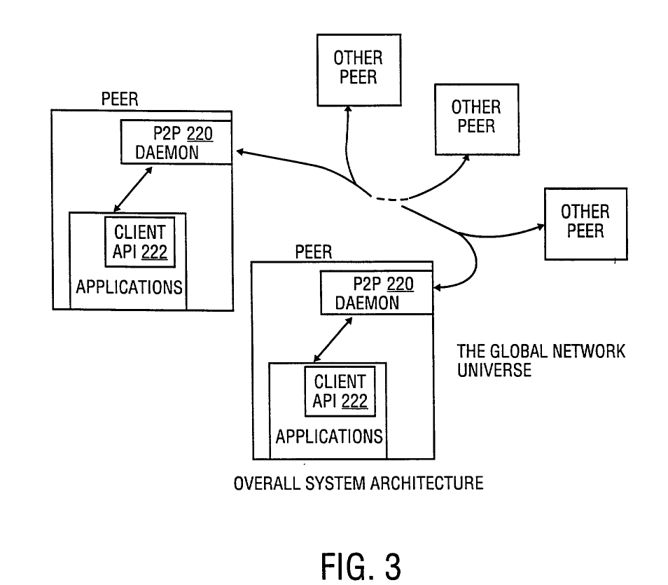

In one embodiment, as illustrated in FIG. 3, the peer-to-peer nodes each include a peer-to-peer daemon 220 and a client API 222 to be linked into applications using the peer-to-peer service. The peer-to-peer daemon is responsible for connecting with the peer-to-peer daemons at other peer-to-peer nodes to form neighboring relationships and to transmit queries/data/resources.

In one embodiment, the peer-to-peer daemon provides support for peer-to-peer operations. The daemon handles the transport of metadata, actual data, and query requests.

In one embodiment, the basic unit of traffic on the peer-to-peer network is a packet. One embodiment of a packet contains the following fields:

1. Command: the type or the purpose of the request contained in the packet.

2. Arguments: the list of arguments specific to the command.

3. Auxiliary information for the packet (e.g., GUID, made time, expiration time, sequence number, time to live value, a cost value, and ID of the node that send this request).

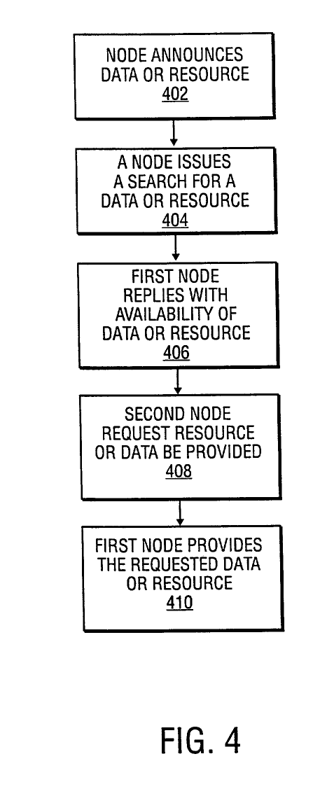

In one embodiment, the following example commands are used as described in the method described in the flow diagram of FIG. 4. In step 402 NAME GUID is announced. The NAME is a user-provided meta-description of a resource, and the GUID is the system-assigned id for the resource. This command informs neighboring peer nodes of the presence of a new resource.

In step 404, a query SEARCH-STRING is issued by a node searching for data/resource. The SEARCH-STRING is a user-specified query searching for data/resources. In one embodiment, each node interprets the query as it sees fit; and the requesting node does not specify a standard query language or query semantics.

For example, in one embodiment, a request for media data consist of two parts: a description of the media data requested as well as, a description of the format in which the media data should be delivered. An example of a video delivery format description is: width=320; height=240; bit rate=512kbits/s; type=mpeg4.

For retrieval purpose, media data is described by metadata such as the time of creation, place of creation, content of the data, etc. In one embodiment, each media data has one special metadata field called GUID. The GUID assumes that each media data is unique at its insertion time into the peer-to-peer network, and therefore a globally unique ID should be assigned to it. Replicas (with the same binary representation or in a transcoded representation) will have the same GUID in order to show that they all represent the same ‘unique’ media data.

An example of a metadata description for videos is: title=“The Matrix”; Content=“Meeting Morphius”; or GUID=87245792438952394-SDGK-3453_{[MH1][ik2]}

In step 406, an answer SEARCH-STRING GUID is sent as a reply in response to the query requests. The resource that satisfies the query SEARCH-STRING is identified by GUID. In one embodiment, the command only answers queries and informs of the existence of resources but does not provide the actual data. In one embodiment, the GUID of the resource may change as the ANSWER packet passes through a separate peer node. More specifically, when the data is actually forwarded from the separate subsequent node, the data with an old GUID will be converted to a new copy with a different GUID representing the separate subsequent node.

In step 408, a Get GUID requesting a resource identified by GUID is sent by the node requesting the resource/data. In step 410, a Put GUID DATA [expiration-time] command is sent actually carrying the DATA or the content resource identified by GUID. For a PUT packet, the GUID may change and the data may get transformed to a new format at a separate subsequent node as the packet is transmitted throughout the peer network.

In one embodiment, a cost value inside each packet is used when passing an ANSWER packet. In particular, each node has a cost function that adds a cost value to the cost of the request. The cost function contains the cost function computation handler, which can be installed dynamically by the user and takes two arguments: the request data specification and the real data specification. Given the specifications, the handler computes the actual cost of doing data conversion from the real data specification to the request data specification at this node, if the response node has the capability to do the conversion. The cost value is then added to the Answer packet. The answers are presented to the original querying client who can then choose one data resource/GUID.

In one embodiment, if a local node cannot provide the desired information, it forwards the requests to all its neighbors, minus the node where the request originally comes from. Moreover, in one embodiment, the answer command leaves a record in the nodes along the path of its return to the original querying node. As a result, in one embodiment, each node may keep a record of the GUID of the Answer, the GUID of the answered resource, its metadata, and the GUID of a new copy of the resource if the node supports data conversion and has trancoded/converted the resource.

Thus when a Get command arrives at a node the node may proceed to check its records of past Answers and may change the GUID argument of the Get packet to the incoming GUID of the past Answer packet. Similarly, when the requested resource identified by the incoming GUID actually arrives, the peer node may invoke an external data conversion program to create the resource identified by the outgoing GUID and then put the new resource in the Put packet before forwarding it.

The architecture and methods described above can be stored in the memory of a computer system (e.g., set top box, video recorders, etc.) as a set of instructions to be executed. In addition, the instructions to perform the operations described above could alternatively be stored on other forms of machine-readable media, including magnetic and optical disks. For example, the operations of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the operations as discussed above, could be implemented in additional computer and/or machine readable media, such as discrete hardware components as large-scale integrated circuits (LSI's), application-specific integrated circuits (ASIC's), firmware such as electrically erasable programmable read-only only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system comprising:
A processing unit;
A memory device;
A network interconnection;
A first unit to process an inquiry for data from a peer node, transcode the data before transmitting the data to the peer node, wherein the transcoding includes converting the data into a format that can be processed by the peer node, and transmitting the data to the peer node in a transport specification as requested by the peer node.

2. The system of claim 1, wherein the transport specification is specified by an application at the peer node.

3. The system of claim 1, wherein the inquiry includes a user-specified query generated at the peer node.

4. The system of claim 3, wherein the user-specified query includes a reference to a content of the requested data, and the system includes a content specific query handler to locate the requested data.

5. The system of claim 1, wherein the application at the peer node specifies the transport specification.

6. The system of claim 1, wherein the data is transcoded into a format requested by the peer service layer of the peer node.

7. The system of claim 1, wherein the system includes a programmatic access for applications to a peer-to-peer service layer.

8. The system of claim 1, wherein the data includes multimedia data.

9. The system of claim 1, wherein the peer node is a wireless device and an application support handler included at the system adjusts delivery of the data to a status of the peer node.

10. The system of claim 1, further including the system obtaining the requested data from a second peer node.

11. The system of claim 11, wherein the system receives the data from the second peer node after the second peer node has transcoded the data.

12. The system of claim 1, wherein a peer service layer at the peer node specifies the transport specification in the request for data.

13. The system of claim 1, wherein the data is transcoded in response to a status of a network connection between the system and the peer node.

14. A method comprising:
A first peer node receiving an inquiry for data from a second peer node;
The first peer node transcoding the data before transmitting the data to the second peer node, wherein the transcoding includes converting the data into a format that can be processed by the second peer node and
transmitting the data to the second peer node in a transport specification as requested by the second peer node.

15. The method of claim 14, wherein the transport specification is specified by an application at the second node.

16. The method of claim 14, wherein the inquiry includes a user-specified query generated at the second node.

17. The method of claim 16, wherein the user-specified query includes a reference to a content of the requested data, and the first peer node includes a content specific query handler to locate the requested data.

18. The method of claim 14, wherein the application at the second peer node specifies the transport specification to a peer service layer at the second peer node.

19. The method of claim 14, wherein the data is transcoded into a format requested by the peer service layer of the second peer node.

20. The method of claim 14, wherein the second node includes a programmatic access to the peer-to-peer service layer.

21. The method of claim 14, wherein the data includes multimedia data.

22. The method of claim 14, wherein the second node is a wireless device and an application support handler at the first node adjust delivery of the data to a mobile location of the second node.

23. The method of claim 14, wherein a peer service layer is included at the second node to provide system-level service below an operating system of the second node.

24. The method of claim 14, further including the first node receiving the data from a third node.

25. The method of claim 24, wherein the third node transcodes the data prior to transmitting the data to the first node.

26. The method of claim 14, wherein a peer service layer at the second peer node specifies the transport specification.

27. The machine readable medium of claim 26, wherein a daemon at the first node includes an application interface module, a media transcoding module, a cost evaluation module, and a daemon to daemon communication module.

28. The method of claim 14, further including the second node transcoding the data after receiving the data from the first node, wherein the transcoding includes converting the data into a format that can be processed by the second peer node.

29. An article comprising a computer-readable medium which stores computer-executable instructions, the instructions causing a first peer node to:
A first peer node receiving an inquiry for data from a second peer node;
The first peer node transcoding the data before transmitting the data to the second peer node, wherein the transcoding includes converting the data into a format that can be processed by the second peer node and; transmitting the data to the second peer node in a transport specification as requested by the second peer node.

30. The article of claim 29, wherein the transport specification is specified by an application at the second node.

31. The article of claim 29, wherein the inquiry includes a user-specified query generated at the second node.

32. The article of claim 31, wherein the user-specified query includes a reference to a content of the requested data, and the first peer node includes a content specific query handler to locate the requested data.

33. The article of claim 29, wherein the second and first peer nodes include tables mapping user-defined names or metadata references to Globally Unique Identifiers identifying data stored within a network of peer-to-peer nodes.

34. The article of claim 29, wherein the application at the second peer node specifies the transport specification to a peer service layer at the second peer node.

35. The article of claim 29, wherein the data is transcoded into a format requested by the peer service layer of the second peer node.

36. The article of claim 29, wherein the second node includes programmatic access to the peer-to-peer service layer.

37. The article of claim 29, wherein the data includes multimedia data.

38. The article of claim 29, wherein the second node is a wireless device and an application support handler at the first node adjust delivery of the data to a mobile location of the second node.

39. The article of claim 29, wherein the instructions further cause the first node to receive the data from a third node, prior to transmitting the data to a second node.

40. The article of claim 39, wherein a peer service layer at the second peer node specifies the transport specification.

41. The article of claim 41, wherein the data is transcoded in response to a status of a network connection between the first peer node and the second peer node.
